(19) United States
(12) Patent Application Publication
(10) Pub. No.: US 2016/0301295 A1
(43) Pub. Date: Oct. 13, 2016

(54) POWER GENERATION SYSTEMS

(71) Applicant: POWER PARTNERS INTERNATIONAL, LLC, NEWPORT BEACH, CA (US)

(72) Inventors: STEPHEN REGIER, CARLSBAD, CA (US); ALBERT S. HILL, MURRIETA, CA (US)

(21) Appl. No.: 14/683,925

(22) Filed: Apr. 10, 2015

(51) Int. Cl. H02K 47/04; H02J 5/00

(52) U.S. Cl. CPC H02K 47/04; H02J 5/00; Y10S 74/09; H02K 53/00

(57) ABSTRACT

The present disclosure is directed to several embodiments or variations of a power generation system. Several of these variations use the same power generators and also include one or more prime movers that supply mechanical power to the generators. In a first embodiment of the power generation system, two single drive through-shaft generators adapted to produce electric power are configured to be driven by a common prime mover. In a second, alternative embodiment of the power generation system, a plurality of generators is arranged into first and second generator groups. Each of the first and second generator groups is operably associated with an independent motor, which allows the power output to be controlled via adjustment to the applied power of the independent motors.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND OF THE INVENTION

1. Technical Field of the Invention

The present disclosure relates generally to a power generation system for the generation of electricity. More particularly, the present disclosure relates to a power generation system together with solar panels or wind generators that is capable of operating continuously.

2. Discussion of the Related Art

Electric power can be generated from coal, oil, gas, wind, ground heat, and solar energy. As energy sources based on fossil fuels become increasingly expensive, the world has turned to renewable energy sources. Although solar energy comprises a very abundant source, conversion to useable forms of energy can be expensive. An increasing demand for electric power continues to push the need for innovative new ways to generate electric power. There is a continuing need for new sources of energy that utilize renewable sources to generate that energy.

### BRIEF SUMMARY OF THE INVENTION

According to an aspect of the present disclosure, there is provided a power generation system. The power generation system includes a plurality of single drive through-shaft generators adapted to produce electric power and a prime mover adapted to supply mechanical power to the plurality of generators. The power generation system also includes a battery bank, a DC-to-AC inverter, and a power stabilizer. The prime mover is electrically coupled to the battery bank. The plurality of generators is electrically coupled to the DC-to-AC inverter. An output of the DC-to-AC inverter is electrically coupled to the power stabilizer. An output of electric power above that consumed by the prime mover is provided by the power stabilizer during operation of the plurality of generators.

According to another aspect of the present disclosure, there is provided a power generation system including a battery bank electrically coupled to a renewable energy source, and a plurality of generators adapted to produce electric power. The plurality of generators is configured to be driven by a hydraulic drive system. The hydraulic drive system includes a hydraulic gear motor operably coupled to a hydraulic pump. The hydraulic pump is powered by an electric motor. The electric motor is electrically coupled to the battery bank. The power generation system also includes an AC-to-DC (or DC-to-AC) inverter for supplying electric power to the electric motor, a DC-to-AC inverter, and a power stabilizer. The plurality of generators is electrically coupled to the DC-to-DC and/or DC-to-AC inverter. A first output of the DC-to-AC inverter is electrically coupled to the AC-to-DC inverter. A second output of the DC-to-AC inverter is electrically coupled to the power stabilizer. An output of electric power above that consumed by the hydraulic drive system is provided by the power stabilizer during operation of the plurality of generators.

According to another aspect of the present disclosure, there is provided a power generation system including a battery bank electrically coupled to a renewable energy source, and first and second groups of generators adapted to produce electric power. The power generation system includes a primer mover including a first motor and a second motor. The first group of generators is adapted to be driven by the first motor. The second group of generators is adapted to be driven by the second motor. The power generation system also includes a DC-to-DC and/or DC-to-AC inverter and a power stabilizer. The first and second groups of generators are electrically coupled to the DC-to-AC inverter. An output of the DC-to-AC inverter is electrically coupled to the power stabilizer. Adjustment to applied power of either or both of the first motor and the second motor controls power output of the power stabilizer.

### BRIEF DESCRIPTION OF THE DRAWINGS

Objects and features of the presently-disclosed power generation systems will become apparent to those of ordinary skill in the art when descriptions of various embodiments thereof are read with reference to the accompanying drawings, of which:

FIG. 1 is a block diagram of a power generation system in accordance with an embodiment of the present disclosure; and

FIG. 2 is a block diagram of a power generation system in accordance with another embodiment of the present disclosure.

### DETAILED DESCRIPTION OF THE INVENTION

Hereinafter, embodiments of a power generation system are described with reference to the accompanying drawings. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

As it is used in this description, “transmission line” generally refers to any transmission medium that can be used for the propagation of signals from one point to another.

Various embodiments of the present disclosure provide a power generation system together with solar panels (or wind generators, or other renewable energy source) that preferably provides power twenty-four hours a day for as long as necessary. Embodiments of the presently-disclosed power generation system may provide alternating current (AC), direct current (DC), or direct mechanical force. Control systems and/or electronic devices may need to be employed, e.g., computers, controllers, user interfaces, sensors, switches, vents, generator connections and other operational systems. The design of these systems and devices is within the ability of one skilled in the relevant arts without undue experimentation or further invention, and may vary depending on the particular application on which the invention is being implemented.

Embodiments of the presently-disclosed power generation system include one or more generators adapted to produce electric power. Generally, each generator has a stator and a rotor that rotates with respect to the stator. The power generation systems also include one or more prime movers that supply mechanical power to the rotors. The presently-disclosed systems can be designed as a stand-alone electrical power generation system that operates without the use of fossil fuel. Preferably, the power generation systems are scalable from 5 kW to 100 MW utility grade continuous baseload power production.

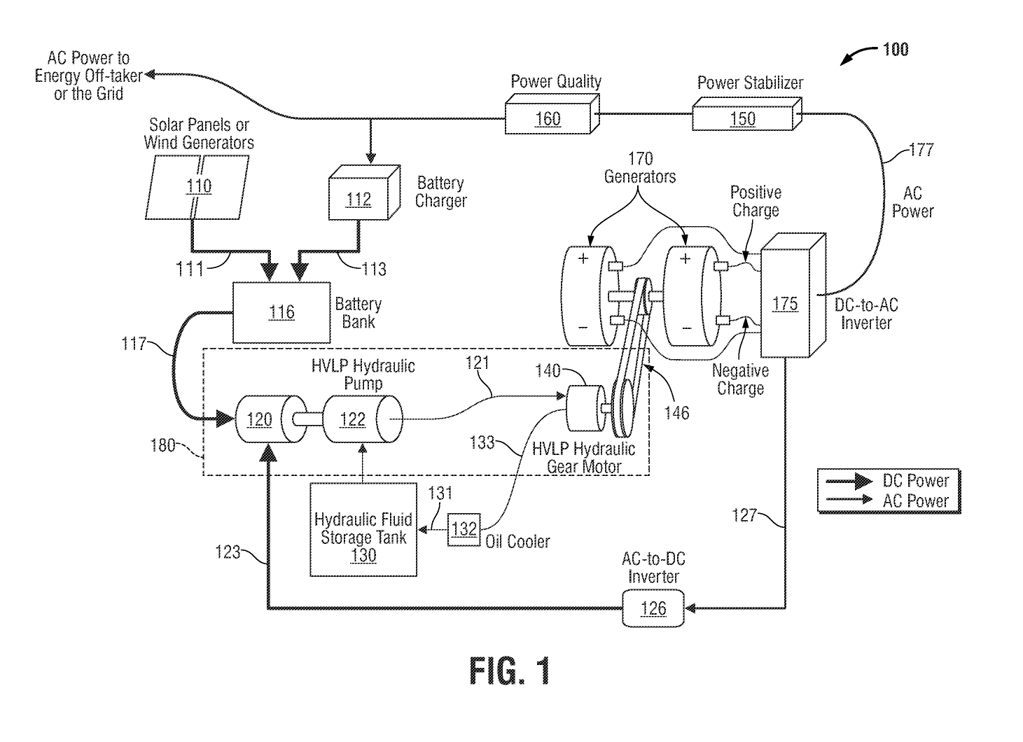

Referring now to FIG. 1, the power generation system 100 is shown. The power generation system 100 includes two generators 170 driven by a prime mover 180, e.g., a hydraulic drive system. The power generation system 100 is adapted to provide an output of electric power above that consumed by the prime mover 180.

Preferably the generators 170 are Agni Motors model 151/151R. Those skilled in the art will recognize that other DC motors (e.g., providing low shaft speed and high torque) are contemplated. As seen in FIG. 1, the positive and negative output terminals of the generators 170 are connected to a DC-to-AC inverter 175. Preferably, the DC-to-AC inverter 175 is a 6000W 48V DC to 120V AC inverter. In the preferred embodiment, the DC-to-AC inverter 175 is an AIMS Power Model No. PICOGLF60W48V120V. Those skilled in the art will recognize that other DC-to-AC inventers are contemplated. As described in more detail below, in the preferred embodiment, the DC-to-AC inverter 175 has two outputs.

The power generation system 100 includes a drive motor 140 operably coupled to a drive 146, which, in turn is operably coupled to the generators 170. In some embodiments, the drive 146 may be a shaft and pulley. Preferably, the pulley is a V-belt pulley, 1 inch fixed, 3.95 inch outer diameter, cast iron. In the preferred embodiment, the pulley is the TB Wood's Model No. 2BK401 (Granger Item No. 5UHL3) V-Belt Pulley. In other embodiments, the drive 146 may be a gear driven mechanism.

The drive 146 is powered by the drive motor 140. In some embodiments, the drive motor 140 is a high-volume low-pressure (HVLP) hydraulic gear motor. Preferably the drive motor 140 is a bi-rotational fluid motor adapted to provide suitable flow characteristics, e.g., flow @ 1800 RPM/1000 PSI 4.3 GPM, flow @ 3600 RPM/1000 PSI 9.1 GPM, nominal flow @ 1200 RPM 3.7 GPM. In the preferred embodiment, the drive motor 140 is the Concentric Model No. 1070033 (Granger Item No. 4F659) Hydraulic Gear Pump/Motor. Those skilled in the art will recognize that other hydraulic gear motors are contemplated.

The drive motor 140 is fluidly coupled through a conduit 121 (also referred to herein as “feed 121”) to a HVLP hydraulic pump 122. Additionally, the drive motor 140 is fluidly coupled through a conduit 133 (also referred to herein as “return 133”) to a fluid cooling apparatus 132 (also referred to herein as “oil cooler 132”). The feed 121 and the return 133 may include any suitable configuration of fluid feed lines. Those skilled in the art will recognize that the feed 121 and/or the return 133 may additionally include connectors, valves, pressure sensors, and/or pressure switches.

A hydraulic fluid storage tank 130 may be provided, e.g., as a reservoir for the HVLP hydraulic pump 122. In some embodiments, the oil cooler 132 is fluidly coupled via a conduit 131 to the hydraulic fluid storage tank 130.

The HVLP hydraulic pump 122 is operated by a pump motor 120. The pump motor 120 may be a DC or AC electric motor. Preferably, the pump motor 120 is a 3 HP, 1755 RPM, 230V electric motor. In the preferred embodiment, the pump motor 120 is the Marathon Motors Model No. 184TBFW7041 (Granger Item No. 21AJ23) Pump Motor. Those skilled in the art will recognize that other pump motors are contemplated. Although shown as separate components in FIG. 1, the drive motor 140, the HVLP hydraulic pump 122 and the pump motor 120 may be integrated into a single component.

The pump motor 120 may be adapted to receive power from one or more sources. In the preferred embodiment, the pump motor 120 is electrically coupled via a transmission line 117 to a battery bank 116. The battery bank 116 may be composed of a single battery (e.g., a lithium-ion battery) or multiple, interconnected batteries that work as one large battery at a required voltage and amp-hour capacity. The battery bank 116 may include one or more interconnect cables (e.g., 12 inch 2/0 gauge interconnect cables). The configuration of the battery bank 116 may be varied depending on the system design. Too small a battery bank risks overcharging and can destroy the batteries. A battery bank that is too large for the system will be damaged by long term undercharging, unless a supplemental source of battery charging is provided.

In some embodiments, as shown for example in FIG. 1, the battery bank 116 is electrically coupled via a transmission line 113 to a battery charger 112. In the illustrated embodiment, the battery charger 112 receives electric power from the generators 170. Additionally, or alternatively, the battery bank 116 may be electrically coupled via a transmission line 117 to an energy source 110, e.g., a renewable energy source. Those skilled in the art will recognize that a variety of methods may be used to convert sources of renewable energy into electricity, e.g., wind power, solar power, hydro power and geothermal energy. In some embodiments, the energy source 110 may include one or more photovoltaic solar modules composed of multiple, interconnected solar cells. In the preferred embodiment, the solar panels are the SolarWorld Model No. SW310-315MONO (“Sunmodules Pro-Series XL”). In other embodiments, the energy source 110 may include wind generators and/or other renewable energy sources.

As seen in FIG. 1, a first output of the DC-to-AC inverter 175 is electrically coupled via a transmission line 127 to an AC-to-DC inverter 126, which, in turn, is electrically coupled via a transmission line 123 to the pump motor 120. A second output of the DC-to-AC inverter 175 is electrically coupled via a transmission line 177 to a power stabilizer/maximizer 150. The power stabilizer/maximizer 150 receives power directly from the DC-to-AC inverter 175 and stabilizes and maximizes power. In the preferred embodiment, the power stabilizer 150 is the Celec Enterprises Model tradename: “PowerQ”. The power stabilizer 150 may be electrically coupled to a power quality device 160. The power quality device 160 provides further cleaning and stabilization of the power. Preferably the power quality device 160 reduces apparent power (kVA), real power (kW) and reactive power (kVAR) allowing the loads to add without increasing transformer or switch gears. In the preferred embodiment, the power quality device 160 is the Celec Enterprises Model No. M-250 (“Smart Power Saver”). Those skilled in the art will recognize that other power quality devices may be employed.

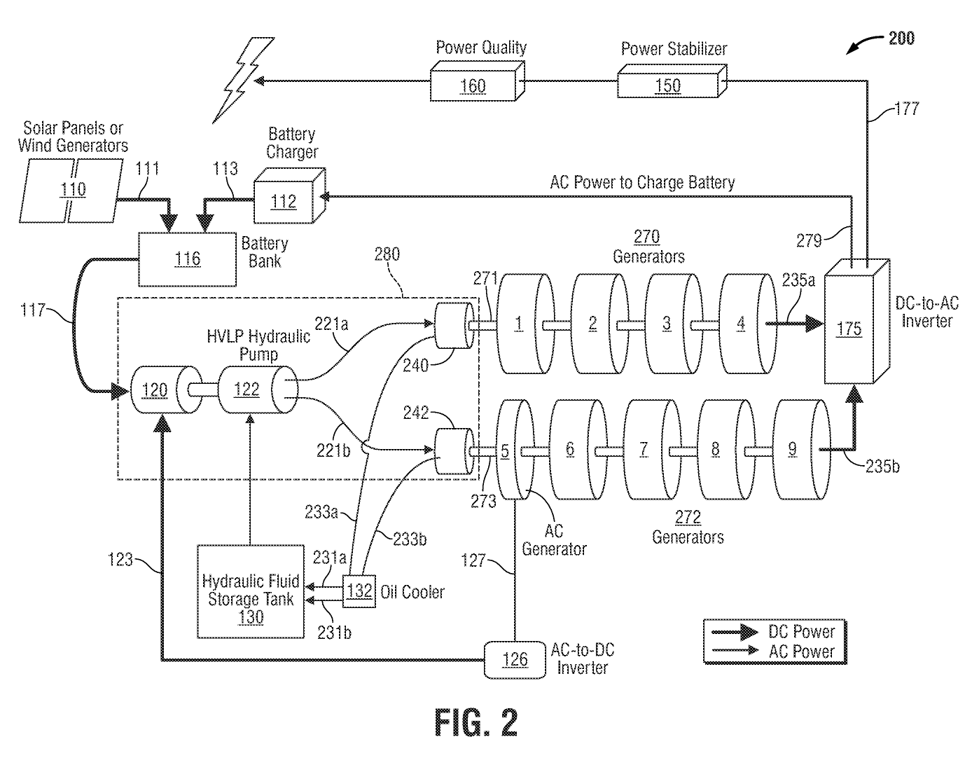

Those skilled in the art will recognize that the coupling of multiple generators to a single prime mover facilitates control of the power output by the generators via adjustments to the common prime mover. The capability of a power generation system to make such adjustments may improve the power rating of the system. In a second, alternative embodiment of the power generation system (generally shown as 200 in FIG. 2), a plurality of generators is arranged into first and second generator groups with each group being mechanically coupled to a common drive shaft. Each of the first and second generator groups may be operably associated with an independent prime mover via the common drive shaft traversing through the generators, which allows the power output to be controlled via adjustment to the applied power of the independent prime movers.

Referring now to FIG. 2, the power generation system 200 is shown. The power generation system 200 includes a first generator group 270 and a second generator group 272. In the illustrative embodiment shown in FIG. 2, the first generator group 270 includes four through-shaft generators and the second generator group 272 includes five through-shaft generators. Those skilled in the art will recognize that various other configurations of generator groups can be employed. The power generation system 200 includes a prime mover 280, e.g., a hydraulic drive system, adapted to drive the first generator group 270 and the second generator group 272. In the illustrative embodiment shown in FIG. 2, the prime mover 280 includes a first motor 240 operably coupled to the common shaft 271 of the first generator group 270, and a second motor 242 operably coupled to the common shaft 273 of the second generator group 272. Those skilled in the art will recognize that various other apparatus can be employed for generating a rotational movement of the common shaft 271 of the first generator group 270 and the common shaft 273 of the second generator group 272.

As seen in FIG. 2, the hydraulic drive system includes a first feed 221a and a second feed 221b. The first feed 221a is configured to fluidly couple the hydraulic pump 122 to the first motor 240 associated with the first generator group 270. The second feed 221b is configured to fluidly couple the hydraulic pump 122 to the second motor 242 associated with the second generator group 272. The first and second feeds 221a and 221b, respectively, may be defined by any suitable structure. Additionally, the hydraulic drive system includes a first return 233a and a second return 233b. The first return 233a is configured to fluidly couple the first motor 240 associated with the first generator group 270 to the oil cooler 132. The second return 233b is configured to fluidly couple the second motor 242 associated with the second generator group 272 to the oil cooler 132. The first and second returns 233a and 233b, respectively, may be defined by any suitable structure. Those skilled in the art will recognize that other cooling apparatus may be employed in lieu of or as a supplement to the oil cooler 132.

In some embodiments, as shown for example in FIG. 2, one of the generators (e.g., generator 5) of the second generator group 272 may be an AC generator, which can be supplied by various manufacturers. In some embodiments, the battery charger 112 is electrically coupled via a transmission line 279 to the inverter 175.

Initial power to start the power generation systems 100 and 200 comes from the battery bank 116. In the preferred embodiment, once started the battery bank 116 is automatically disconnected and goes into recharge mode. During operation of the power generation system 100, the pump motor 120 operates the HVLP hydraulic pump 122, which, in turn provides pressurized fluid (e.g., 2000 psi) via the feed 121 to drive the drive motor 140. Operation of the drive motor 140 drives the generators 170. DC current produced by the generators 170 is applied to the inverter 175.

During operation of the power generation system 200, DC current produced by the first generator group 270 and a second generator group 272 is applied to the inverter 175. Initial power to start the power generation systems 100 and 200 comes from the battery bank 116. In the preferred embodiment, once started the battery bank 116 is automatically disconnected and goes into recharge mode. During operation of the power generation system 100, the prime mover 180 generates a rotational movement of the single drive through-shaft generators 170. In the illustrative embodiment shown in FIG. 1, the prime mover 180 is a hydraulic drive system wherein the pump motor 120 operates the HVLP hydraulic pump 122, which, in turn provides pressurized fluid (e.g., 2000 psi) via the feed 121 to drive the drive motor 140. Operation of the drive motor 140 drives the generators 170. DC current produced by the generators 170 is applied to the DC-to-AC inverter 175. The AC-to-DC inverter 126 receives input power from the DC-to-AC inverter 175, and, in turn, supplies power to the pump motor 120. The power stabilizer/maximizer 150 receives power from the DC-to-AC inverter 175 and stabilizes, maximizes and cleans the power. The output of electric power from the power stabilizer/maximizer 150 is transmitted to the Power Quality box 160 where the power is further cleaned and corrected. The final, net output from the Power Quality box 160 is above that consumed by the prime mover 180 during operation of the generators 170.

During operation of the power generation system 200, DC current produced by the first generator group 270 and a second generator group 272 is applied to the DC-to-AC inverter 175. Adjustment to applied power of the first motor 240 associated with the first generator group 270 and/or the second motor 242 associated with the second generator group 272 controls power output through the DC-to-AC inverter 175 and to the power stabilizer/maximizer 150 and the Power Quality box 160. The AC-to-DC inverter 126 receives input power from the AC generator 5, and, in turn, supplies power to the pump motor 120. The final, net output from the Power Quality box 160 is above that consumed by the prime mover 280 during operation of the first generator group 270 and the second generator group 272.

Although embodiments have been described in detail with reference to the accompanying drawings for the purpose of illustration and description, it is to be understood that the disclosed processes and apparatus are not to be construed as limited thereby. It will be apparent to those of ordinary skill in the art that various modifications to the foregoing embodiments may be made without departing from the scope of the disclosure.

What is claimed is:

1. A power generation system, comprising:
a battery bank;
a plurality of generators adapted to produce electric power;
a prime mover adapted to supply mechanical power to the plurality of generators, wherein the prime mover is electrically coupled to the battery bank;
a DC-to-AC inverter, wherein the plurality of generators is electrically coupled to the DC-to-AC inverter; and
a power stabilizer, wherein an output of the DC-to-AC inverter is electrically coupled to the power quality device,
wherein an output of electric power above that consumed by the prime mover is provided by the power stabilizer during operation of the plurality of generators.

2. The power generation system of claim 1, wherein the prime mover is a hydraulic drive system.

3. The power generation system of claim 2, wherein the hydraulic drive system includes:
a hydraulic pump;
a hydraulic gear motor fluidly coupled to the hydraulic pump; and
an electric motor adapted to provide power to the hydraulic pump.

4. The power generation system of claim 3, wherein the electric motor is electrically coupled to the battery bank.

5. The power generation system of claim 3, further comprising:
a cooling apparatus fluidly coupled to the hydraulic gear motor; and
a hydraulic fluid storage tank fluidly coupled between the cooling apparatus and the hydraulic pump.

6. The power generation system of claim 1, wherein the battery bank is electrically coupled to a first energy source.

7. The power generation system of claim 6, wherein the first energy source is a renewable energy source.

8. The power generation system of claim 6, wherein the first energy source is composed of at least one solar panel or wind turbine.

9. The power generation system of claim 1, further comprising a battery charger electrically coupled to the battery bank.

10. The power generation system of claim 9, wherein the battery charger is electrically coupled to an output of the power stabilizer.

11. A power generation system, comprising:
a battery bank electrically coupled to a renewable energy source;
a plurality of generators adapted to produce electric power, the plurality of generators configured to be driven by a hydraulic drive system;
the hydraulic drive system including a hydraulic gear motor operably coupled to a hydraulic pump, the hydraulic pump powered by an electric motor, wherein the electric motor is electrically coupled to the battery bank;
a DC-to-AC inverter, wherein the plurality of generators is electrically coupled to the DC-to-AC inverter;
an AC-to-DC inverter for supplying electrical power to the electric motor, wherein a first output of the DC-to-AC inverter is electrically coupled to the AC-to-DC inverter; and
a power stabilizer, wherein a second output of the DC-to-AC inverter is electrically coupled to a power stabilizer,
wherein an output of electric power above that consumed by the hydraulic drive system is provided by the power stabilizer during operation of the plurality of generators.

12. The power generation system of claim 11, wherein the renewable energy source is composed of at least one solar panel or wind turbine.

13. The power generation system of claim 11, further comprising a battery charger electrically coupled to the battery bank.

14. The power generation system of claim 13, wherein the battery charger is electrically coupled to an output of the power stabilizer.

15. A power generation system, comprising:
a battery bank electrically coupled to a renewable energy source;
a primer mover including a first motor and a second motor;
a first group of generators adapted to produce electric power, the first group of generators adapted to be driven by the first motor;
a second group of generators adapted to produce electric power, the second group of generators adapted to be driven by the second motor;
a DC-to-AC inverter, wherein the first and second groups of generators are electrically coupled to the DC-to-AC inverter; and
a power stabilizer, wherein an output of the DC-to-AC inverter is electrically coupled to the power stabilizer,
wherein adjustment to applied power of either or both of the first motor and the second motor controls power output of the power stabilizer.

16. The power generation system of claim 15, wherein an output of electric power above that consumed by the prime mover is provided by the power stabilizer during operation of the first and second groups of generators.

17. The power generation system of claim 15, wherein either or both of the first motor and the second motor is driven by a hydraulic drive system.
